(19) United States
(12) Patent Application Publication
(10) Pub. No.: US 2025/0087855 A1
(43) Pub. Date: Mar. 13, 2025

(54) System and Method of Preventing a Rechargeable Battery for an Electrically-Motorized Personal Vehicle from Overheating

(71) Applicant: Edmond Monnet, Hackensack, NJ (US)

(72) Inventor: Edmond Monnet, Hackensack, NJ (US)

(21) Appl. No.: 18/884,103

(22) Filed: Sep. 12, 2024

Related U.S. Application Data
(60) Provisional application No. 63/582,149, filed on Sep. 12, 2023.

(51) Int. Cl. H01M 50/581; G08B 21/18; H01M 10/42; H01M 10/44; H01M 10/48; H01M 50/244; H01M 50/249

(52) U.S. Cl. CPC H01M 50/581; G08B 21/182; H01M 10/425; H01M 10/443; H01M 10/486; H01M 50/244; H01M 50/249; H01M 2010/4278; H01M 2200/10

(57) ABSTRACT

A system of preventing a rechargeable battery for an electrically-motorized personal vehicle from overheating includes at least one rechargeable battery, at least one temperature sensor, at least one computerized thermostat, at least one circuit breaker, at least one enclosure, and at least one external power source. This system implements a method through the following steps. The temperature sensor first captures a current temperature reading. The computerized thermostat then converts the current temperature reading into a current temperature measurement. If the current temperature measurement is greater than or equal to a maximum temperature threshold, the circuit breaker then stops an electrical current from the external power source to the rechargeable battery in order to prevent the rechargeable battery from overheating. The aforementioned steps are periodically executed as a plurality of iterations, until the rechargeable battery is electrically disconnected from the external power source.

The current application claims a priority to the U.S. provisional patent application Ser. No. 63/582,149 filed on Sep. 12, 2023.

### FIELD OF THE INVENTION

The present invention generally relates to a programmable thermostat-controlled circuit breaker device. More specifically, the present invention is an automated and programmable thermostat device that allows users to prevent lithium-ion e-bikes batteries from catching fire due to overheating while being charged. The purpose of the built-in circuit breaker is to stop the charging process and therefore the overheating.

### BACKGROUND OF THE INVENTION

Electric scooters and e-bikes are rising in popularity. E-bikes are zero-emission vehicles since they use lithium-ion batteries. Riding an e-bike means no contribution to global warming and no emission of pollutants into the atmosphere. Thus, e-micro mobility (e-bikes and e-scooters) can offer numerous benefits to individuals and communities such as healthy movement, emissions reduction, reducing the need for vehicles, and a general diversification of transportation options. However, lithium batteries (and indeed any type of rechargeable battery) do not like to be left discharged. It is recommended to recharge as soon as is reasonably possible after the battery goes flat. However, overcharging the e-bike battery can cause excessive heat buildup and increase the risk of overheating. Most electric bikes have lithium-ion batteries that naturally heat up while the device is in use. This type of batteries can also get hot if you're charging them with a too powerful charger too quickly. Overheating can further cause the battery to explode and cause a fire. Thus, a system that can detect heating of the battery during charging and stop charging if the heat level surpasses a critical level is a rare find in the current market.

The objective of the present invention is to provide users with a programmable thermostat-controlled circuit breaker device that can prevent lithium-ion batteries from catching fire due to overheating while being charged. To accomplish this, the present invention comprises a programmable device with a heat sensor linked to a thermostat, that can sense the temperature variations associated with the charging of an e-bike or e-scooter lithium-ion battery. Also, a circuit breaker integrated with the thermostat device prevents the lithium-ion battery of an e-bike from charging if the sensor detects a critical level of heat that can cause the battery to explode and start a fire. Furthermore, the present invention may be controlled using a digital keypad, an app on a mobile device or might be (in the future) vertically integrated to the home security system app with all the other IOT smart devices in the house (e.g., ADT, Vivint, The Slomin Shield, etc.). Additionally, the present invention may be turned into a multiuser platform where two or more monitoring systems built in parallel are linked to two or more charging batteries controlled by one central CPU.

### SUMMARY OF THE INVENTION

The present invention is intended to provide users with a programmable and automated thermostat-controlled circuit breaker all in one device that can prevent batteries from causing fires due to overheating while being charged. To accomplish this, the present invention comprises a programmable and automated device with a heat sensor linked to a thermostat, that can sense the temperature variations associated with the charging process of an e-bike's battery. Further, a circuit breaker integrated with the thermostat device enables a lithium-ion battery of an e-bike from charging if the sensor detects a critical level of heat that can cause the battery to explode and cause a fire. Furthermore, the present invention may be controlled using a digital keypad or an app on mobile devices. Additionally, the present invention may be turned into a multiuser platform where two or more charging batteries could be monitored by one central CPU.

### BRIEF DESCRIPTION OF THE DRAWINGS

FIG. 1 is a block diagram for the system of the present invention with the temperature sensor inside of the enclosure.

FIG. 2 is a block diagram for the system of the present invention with the temperature sensor outside of the enclosure.

FIG. 3 is a flowchart illustrating an overall process for the method of the present invention.

FIG. 4 is a flowchart illustrating a subprocess of setting the maximum temperature threshold with the user interface module.

FIG. 5 is a flowchart illustrating a subprocess of outputting the warning notification generated by the computerized thermostat through the user interface module.

FIG. 6 is a flowchart illustrating a subprocess of setting the maximum temperature threshold with the remote computing device.

FIG. 7 is a flowchart illustrating a subprocess of outputting the warning notification generated by the computerized thermostat through the remote computing device.

FIG. 8 is a flowchart illustrating a subprocess of presetting the maximum temperature threshold with the computerized thermostat.

FIG. 9 is a flowchart illustrating a subprocess of activating the circuit breaker with the computerized smoke detector.

FIG. 10 is a flowchart illustrating a subprocess of outputting the warning notification generated by the computerized smoke detector through the user interface module.

FIG. 11 is a flowchart illustrating a subprocess of outputting the warning notification generated by the computerized smoke detector through the remote computing device.

FIG. 12 is a block diagram of the present invention, wherein thinner flowlines represent electrical connections between components, thicker flowlines represent electronic connections between components, and dashed flow lines indicate the components being communicably coupled

FIG. 13 is a perspective view of the thermostat device according to a preferred embodiment of the present invention.

FIG. 14 is a perspective view of an alternate embodiment of the present invention, wherein multiple batteries may be monitored and protected with a single controlling device.

### DETAIL DESCRIPTIONS OF THE INVENTION

All illustrations of the drawings are for the purpose of describing selected versions of the present invention and are not intended to limit the scope of the present invention.

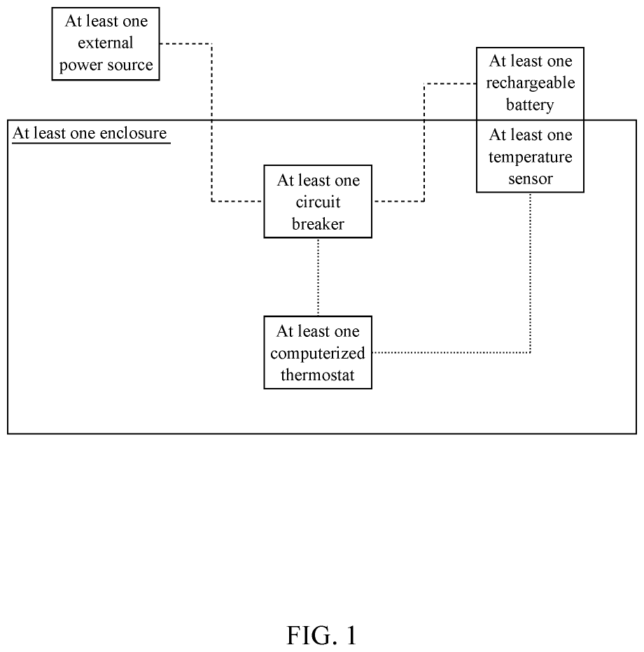

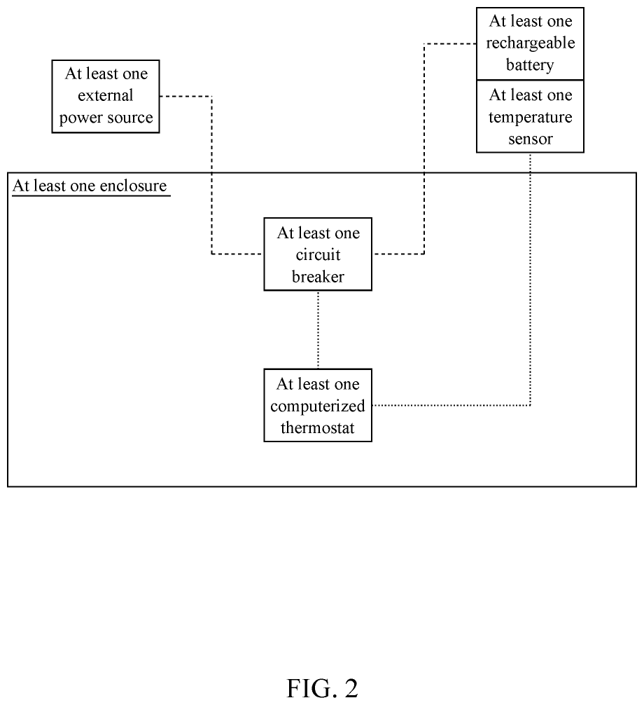

The present invention is a system and a method of preventing a rechargeable battery for an electrically-motorized personal vehicle from overheating. The electrically-motorized personal vehicle is typically an e-bicycle, an e-scooter, or another single-person mode of transportation with a relatively-large lithium-ion battery, which is prone to overheating, starting a fire, exploding, or a combination thereof. Thus, the system of the present invention includes at least one rechargeable battery, at least one temperature sensor, at least one computerized thermostat, at least one circuit breaker, at least one enclosure, and at least one external power source (Step A), which is show in FIGS. 1 and 2. The rechargeable battery is a portable power source for an electrically-motorized personal vehicle (e.g., an e-bicycle, an e-scooter, etc.). The rechargeable battery is preferably a lithium-ion battery. The temperature sensor is used to continuously monitor the temperature of the rechargeable battery and consequently is in thermal communication with the rechargeable battery. The computerized thermostat is a thermostat that has been further configured with a microprocessor to be able to execute some software functionalities (i.e., like a smart-thermostat that is programmable). At least one maximum temperature threshold is a temperature limit for the rechargeable battery to prevent overheating and is stored and/or managed by the computerized thermostat. The rechargeable battery and the external power source are electrically connected to each other through the circuit breaker so that the circuit breaker is able to readily interrupt an electrical current traveling from the external power source to the rechargeable battery. The external power source is preferably a wall outlet. The temperature sensor is electrically connected to the computerized thermostat, while the computerized thermostat is electronically connected to the circuit breaker, which allows for information/data and commands to be digitally communicated between the temperature sensor, the computerized thermostat, and the circuit breaker. The enclosure is used to protect the internal functional components of the present invention from external damage and consequently houses the computerized thermostat and the circuit breaker.

An overall process followed by the method of the present invention protects a rechargeable battery from overheating, catching on fire, exploding, or a combination thereof. The overall process begins by capturing a current temperature reading with the temperature sensor (Step B), and the current temperature reading is a raw electrical signal detected by the temperature sensor. The overall process continues by converting the current temperature reading into a current temperature measurement with the computerized thermostat (Step C) so that the current temperature reading can be understood as the current temperature measurement (i.e., a digital signal) by the computerized thermostat and other computing devices. If the current temperature measurement is greater than or equal to the maximum temperature threshold, the circuit breaker then stops an electrical current from the external power source to the rechargeable battery (Step D), which prevents the rechargeable battery from potentially overheating and may prevent the rechargeable battery from catching on fire or exploding. The overall process concludes by periodically executing a plurality of iterations for Step B through Step D (Step E), until the rechargeable battery is electrically disconnected from the external power source, which allows the present invention to continuously monitor the temperature of the rechargeable battery and to continuously prevent the rechargeable battery from overheating. The plurality of iterations for Step B through Step D can be executed at, but is not limited to, a one-second interval, a ten-second interval, a 30-second interval, or a minute interval.

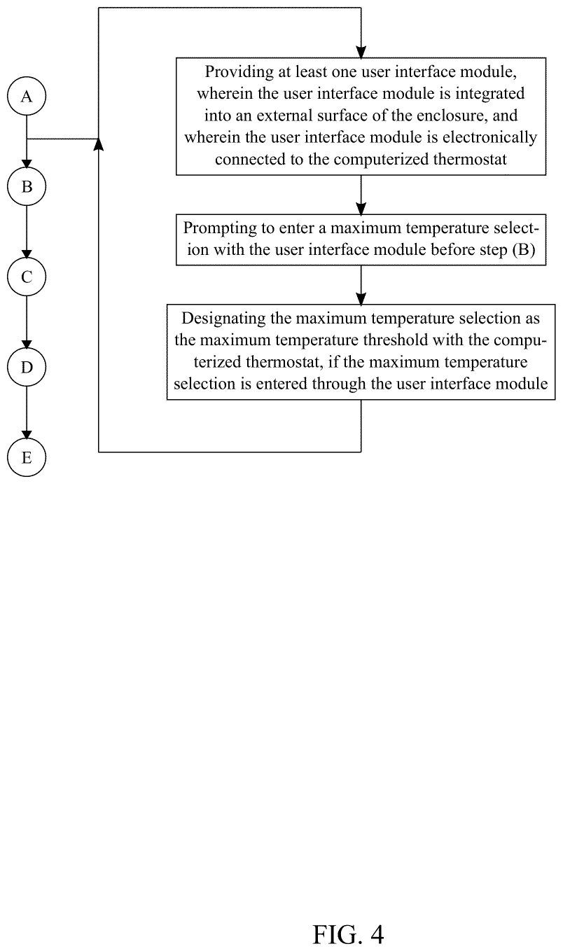

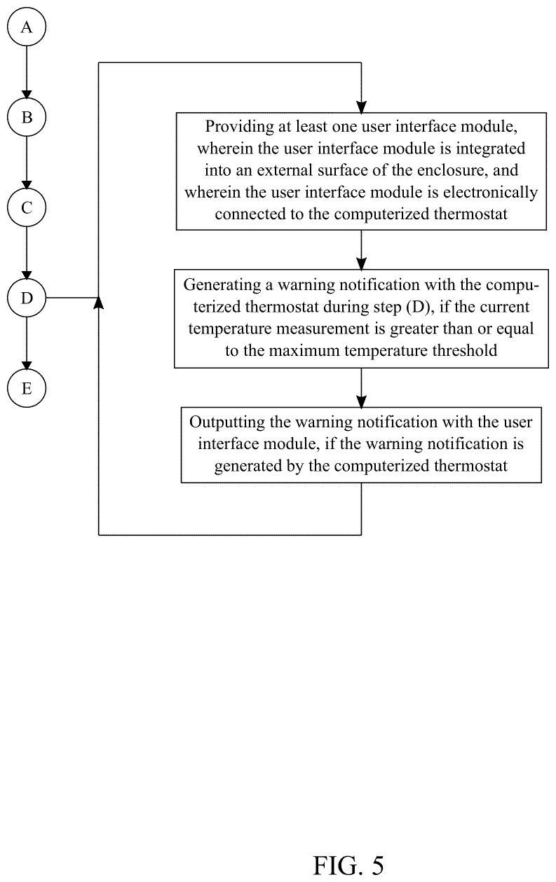

As can be seen in FIGS. 4 and 5, a first embodiment for the system of the present invention includes at least one user interface module, which allows a user to make inputs and/or allows a user to receive outputs through a hardwired interface. The user interface module is integrated into an external surface of the enclosure so that a user can easily access the user interface module. The user interface module is electronically connected to the computerized thermostat, which allows for information/data and commands to be digitally communicated between the computerized thermostat and the user interface device.

As can be seen in FIG. 4, the user interface module enables one subprocess followed by the method of the present invention, which allows a user to select a value for the maximum temperature threshold. This subprocess prompts a user to enter a maximum temperature selection with the user interface module before Step B. In some embodiments, the user interface module is a knob, and the maximum temperature selection is made by rotating the knob in either one direction or another direction. When the maximum temperature selection is entered through the user interface module, this subprocess then designates the maximum temperature selection as the maximum temperature threshold with the computerized thermostat.

As can be seen in FIG. 5, the user interface module enables another subprocess followed by the method of the present invention, which audibly and/or visually and/or tactilely warns a user of an overheating battery. If the current temperature measurement is greater than or equal to the maximum temperature threshold, this subprocess generates a warning notification with the computerized thermostat during Step D. Thus, when the warning notification is generated by the computerized thermostat, the warning notification is then outputted with the user interface module. In some embodiments, the user interface module is a touchscreen, and the touchscreen displays the warning notification as a visually-jarring alert.

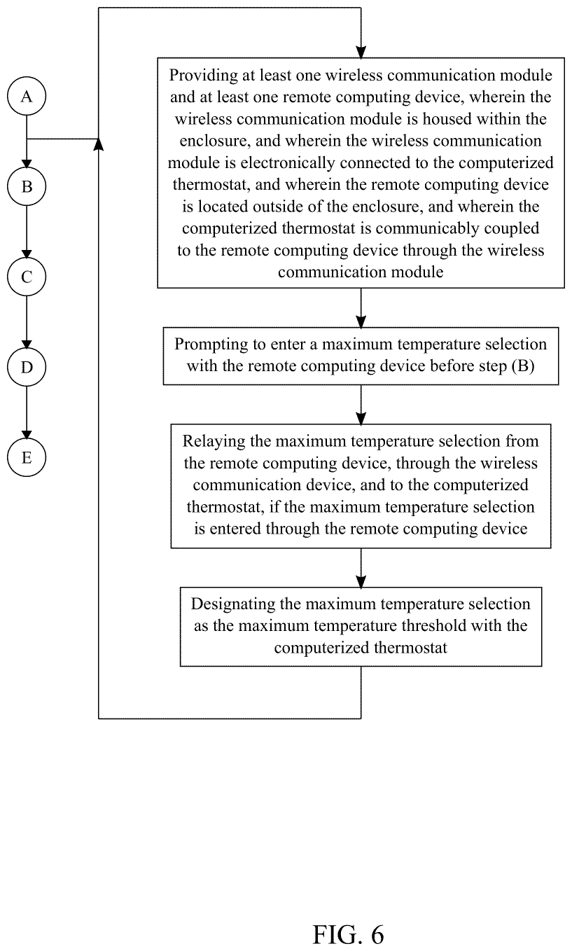

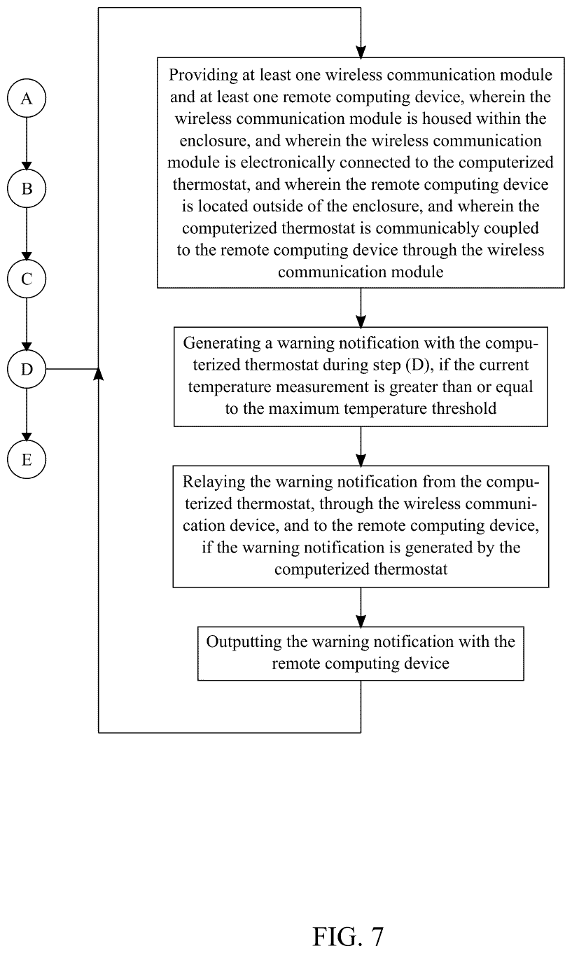

As can be seen in FIGS. 6 and 7, a second embodiment for the system of the present invention includes at least one wireless communication module and at least one remote computing device, which allows a user to make inputs from a remote location and/or allows a user to receive outputs from a remote location. The wireless communication module allows the other electronic components for the system of the present invention to wirelessly communicate with other computing devices. The wireless communication module allows for communication through a personal area network (e.g., Bluetooth, near-field communication, etc.), through a local area network (e.g., WiFi), through a wide area network, or a combination thereof. The remote computing device can be, but is not limited to, a mobile computing device (e.g., a smart-phone, a smart-watch, a pair of smart-glasses, etc.), a desktop, a laptop, or a tablet personal computer. The wireless communication module is housed within the enclosure, which protects the wireless communication module from external damage. The remote computing device is located outside of the enclosure so that a user can easily access the present invention from a remote location (e.g., the rechargeable battery is charging in a garage, while a user is upstairs in their room). The wireless communication module is electronically connected to the computerized thermostat, and the wireless communication module is communicably coupled to the remote computing device through the wireless communication module, which allows for information/data and commands to be digitally communicated between the computerized thermostat and the remote computing device.

As can be seen in FIG. 6, the wireless communication module and the remote computing device enable one subprocess followed by the method of the present invention, which allows a user to select a value for the maximum temperature threshold. This subprocess begins by prompting a user to enter a maximum temperature selection with the remote computing device before Step B. In some embodiments, this prompt is cued through a software application being run on the remote computing device, and the software application can be used to manage a home alarm system or can be dedicated to managing the functionalities of the present invention. When the maximum temperature selection is entered through the remote computing device, this subprocess continues by relaying the maximum temperature selection from the remote computing device, through the wireless communication device, and to the computerized thermostat. This subprocess concludes by designating the maximum temperature selection as the maximum temperature threshold with the computerized thermostat.

As can be seen in FIG. 7, the wireless communication module and the remote computing device enable another subprocess followed by the method of the present invention, which audibly and/or visually warns a user of an overheating battery. When the current temperature measurement is greater than or equal to the maximum temperature threshold, this subprocess begins by generating a warning notification with the computerized thermostat during Step D. When the warning notification is generated by the computerized thermostat, this subprocess continues by relaying the warning notification from the computerized thermostat, through the wireless communication device, and to the remote computing device. This subprocess then concludes by outputting the warning notification with the remote computing device. In some embodiments, the remote computing device is a smart-phone, and the smart-phone outputs the warning notification as a visually-and-audibly-and-tactilely-jarring alert.

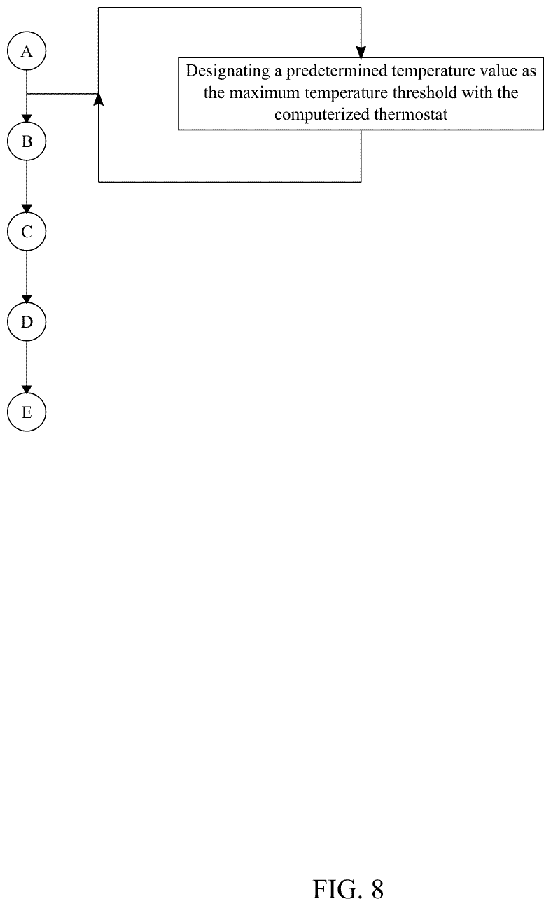

As can be seen in FIG. 8, another subprocess followed by the method of the present invention is setting the maximum temperature threshold to a predetermined temperature value managed by the computerized thermostat. The predetermined temperature value can be determined at the time of manufacturing the present invention and can be programmed into the computerized thermostat. The predetermined temperature value can also be a computed conclusion made by an artificial intelligence model, which would be fed temperature data of the rechargeable battery over time.

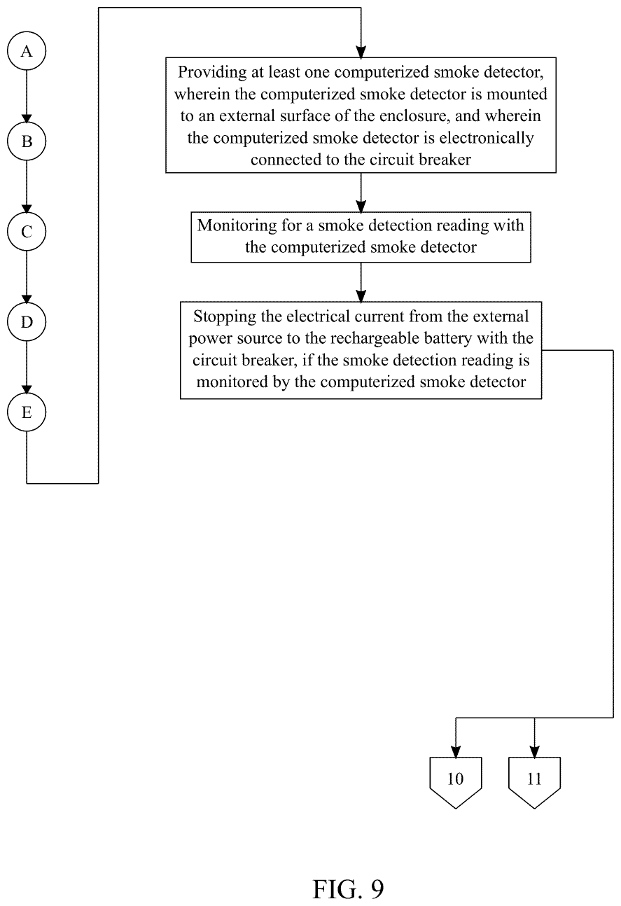

As can be seen in FIGS. 9 through 11, some embodiments for the system of the present invention includes at least one computerized smoke detector, which allows the present invention to identify an overheating battery through the detection of smoke in the surrounding area, instead of temperature. The computerized smoke detector is a smoke detector that has been further configured with a microprocessor to be able to execute some software functionalities (i.e., like a smart-smoke-detector that is programmable). The computerized smoke detector is mounted to an external surface of the enclosure so that the computerized smoke detector is able to readily detect smoke emanating from the rechargeable battery. The computerized smoke detector is electronically connected to the circuit breaker, which allows for information/data and commands to be digitally communicated between the computerized smoke detector and the circuit breaker.

As can be seen in FIG. 9, the computerized smoke detector enables one subprocess followed by the method of the present invention, which allows the present invention to identify an overheating battery through the detection of smoke in the surrounding area, instead of temperature. This subprocess monitors for a smoke detection reading with the computerized smoke detector. If the smoke detection reading is monitored by the computerized smoke detector, the circuit breaker then stops the electrical current from the external power source to the rechargeable battery.

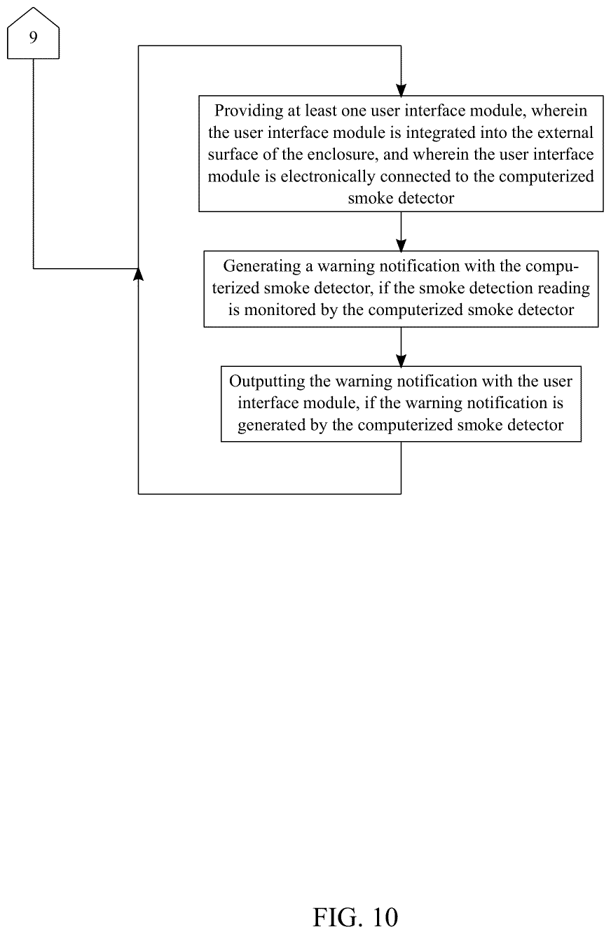

As can be seen in FIG. 10, the computerized smoke detector and the user interface module enable another subprocess followed by the method of the present invention, which audibly and/or visually and/or tactilely warns a user of a smoking battery. If the smoke detection reading is monitored by the computerized smoke detector, this subprocess generates a warning notification with the computerized smoke detector. Thus, when the warning notification is generated by the computerized smoke detector, the warning notification is then outputted with the user interface module. In some embodiments, the user interface module is a touchscreen, and the touchscreen displays the warning notification as a visually-jarring alert.

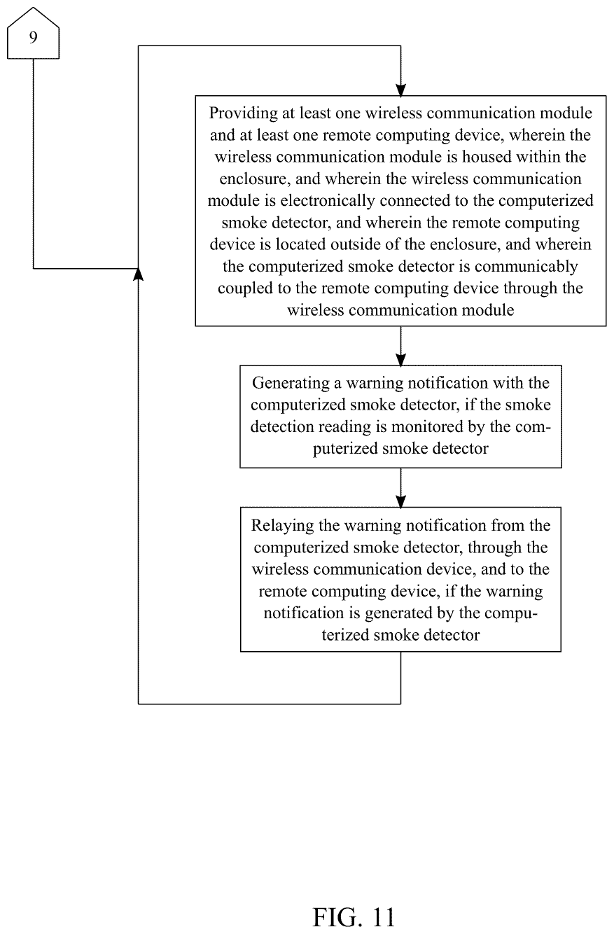

As can be seen in FIG. 11, the computerized smoke detector, the wireless communication module, and the remote computing device enable another subprocess followed by the method of the present invention, which audibly and/or visually and/or tactilely warns a user of a smoking battery. When the smoke detection reading is monitored by the computerized smoke detector, this subprocess begins by generating a warning notification with the computerized smoke detector. When the warning notification is generated by the computerized smoke detector, this subprocess continues by relaying the warning notification from the computerized smoke detector, through the wireless communication device, and to the remote computing device. This subprocess then concludes by outputting the warning notification with the remote computing device. In some embodiments, the remote computing device is a smart-phone, and the smart-phone outputs the warning notification as a visually-and-audibly-and-tactilely-jarring alert.

One physical configuration for the system of the present invention allows the temperature sensor to be housed within the enclosure. Thus, the enclosure needs to be made of a thermally-conductive material (e.g., a kind of metal), and the temperature sensor needs to be mounted adjacent to an internal surface of the enclosure. This physical configuration allows the temperature sensor to be in thermal communication with the rechargeable battery through the enclosure. Alternatively, another physical configuration for the system of the present invention allows the temperature sensor to be located outside of the enclosure. Thus, the temperature sensor needs to be tethered to the enclosure, and the electronic connection between the temperature sensor and the computerized thermostat needs to traverse through this tether.

Another physical configuration for the system of the present invention includes at least one power-in port and at least one power-out port, which allows the electrical power charging the rechargeable battery to travel through the circuit breaker. Thus, the power-in port and the power-out port need to be integrated into the enclosure and need to be electrically connected to each other through the circuit breaker. This arrangement allows the external power source to be electrically plugged into the power-in port and allows the rechargeable battery to be electrically plugged into the power-out port so that the circuit breaker is able to readily interrupt the electrical current traveling from the external power source to the rechargeable battery.

### Supplemental Description

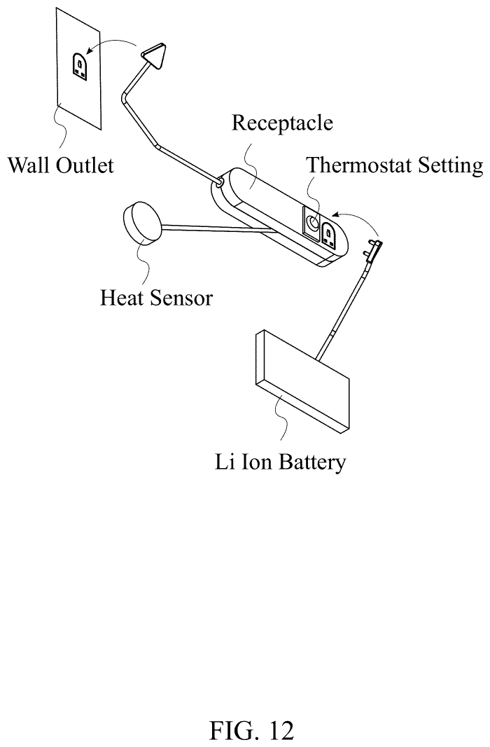

In reference to FIGS. 12 through 14, the present invention is a programmable thermostat device. It is the aim of the present invention to link a heat sensor to a thermostat and a circuit breaker. The purpose of the present invention is to stop a lithium-ion battery of an e-bike or electric scooter from continuing charging if the sensor detects a critical level of heat that can cause the battery to explode and cause a fire. Through a digital keypad or an app on mobile device, the user would enter the battery characteristics like kilowatts, amperes, etc. Following this, a critical heat level would be automatically calculated by the device and the thermostat would be set to a certain temperature. If the thermostat reaches the heat level where an explosion could happen a circuit breaker would automatically interrupt the charging process by preventing any further electricity coming to the battery.

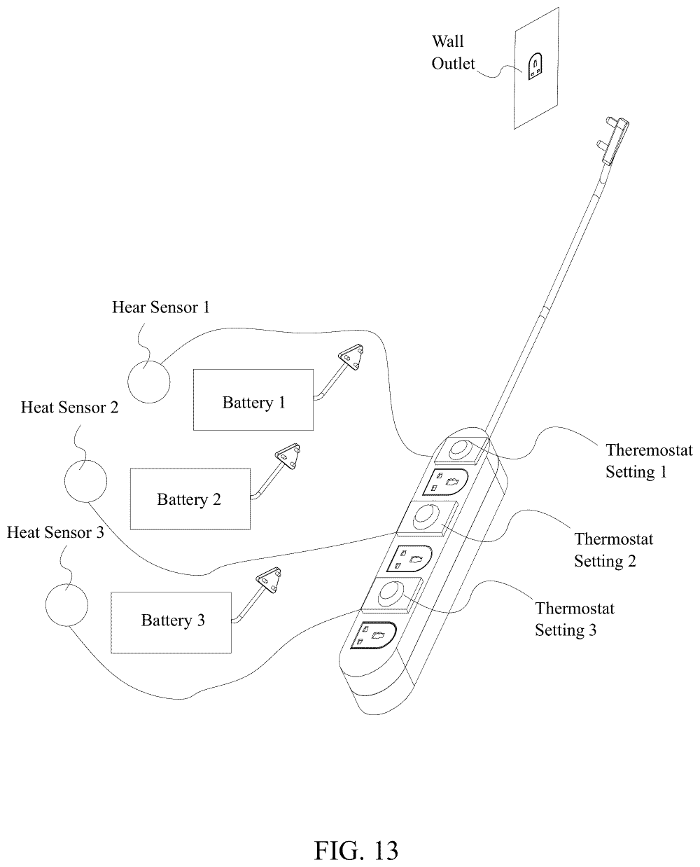

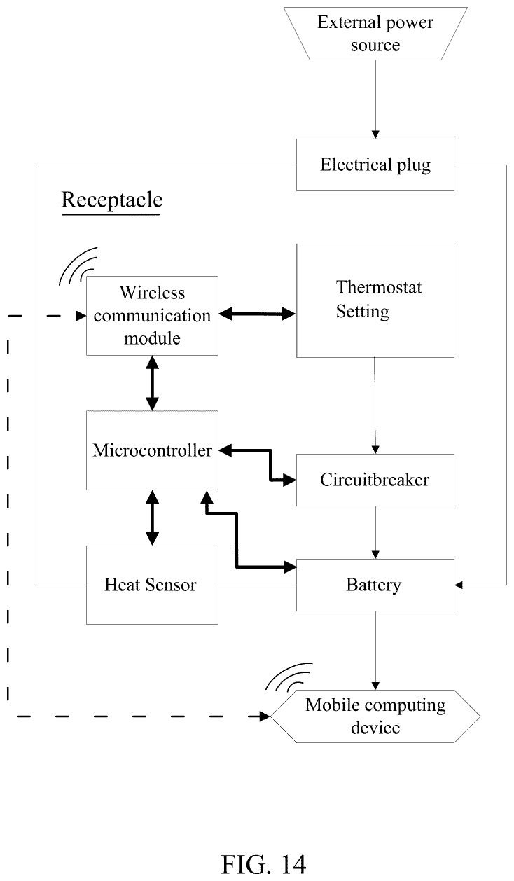

The following description is in reference to FIGS. 12 through 14. According to a preferred embodiment, the present invention comprises a receptacle, a heat sensor, a human interface device (HID) device, a battery, a circuit breaker, a microcontroller, and an external power source. Preferably, the receptacle is a housing that can hold all the electrical and electronic components of the present invention in a safe manner, protected from outside elements. As seen in FIGS. 13 and 14, the receptacle is an elongated cuboid with rounded edges. However, the receptacle may comprise any size, shape, material, components, arrangement of components, etc. that are known to one of ordinary skill in the art, as long as the intents of the present invention are not altered.

A thermostat is a regulating device component which senses the temperature of a physical system and performs actions so that the system's temperature is maintained near a desired setpoint. Thermostats are used in any device or system that heats or cools to a setpoint temperature. Accordingly, in the present invention, the heat sensor and the HID or a thermostat setting device, and associated circuitry together form the thermostat.

Preferably, the battery is a lithium-ion rechargeable battery, and the heat sensor is operably linked to the battery. This is so that the heat sensor can sense temperature variations on the battery during charging and send that information to the microcontroller. In other words, when the sensor detects the critical temperature, there is a feedback mechanism that will stop the battery charging process.

In the preferred embodiment, the HID is a temperature setting device of the thermostat, that may be manually operated to set to a particular temperature. This is so that, based on the specifications of the battery, a user may set the critical temperature at which charging must stop to prevent overheating, by controlling the HID. Preferably, the HID is a knob that is integrated onto a top surface of the receptacle, such that, a user may easily access the HID for performing the various operations associated with the HID. However, it should be noted that the HID may comprise any other shape, size, technology, etc. that are known to one of ordinary skill in the art, as long as the objectives of the present invention are fulfilled. Examples of HID include, but are not limited to switches, digital keypad, touch sensing pads, voice command detector etc.

It is an aim of the present invention to stop charging the battery when a temperature equal to the critical temperature is detected by the heat sensor. To accomplish this, the circuit breaker is mounted within the receptacle and the circuit breaker is electrically connected to the battery and electronically connected to the microcontroller. In other words, if the thermostat reaches the heat level where an explosion could happen the circuit breaker would automatically interrupt the charging process by preventing any further electricity coming to the battery. Preferably, the microcontroller is mounted within the receptacle, so that the associated circuitry and electrical components are placed in a closed safe location. The HID and the circuit breaker are electronically connected to the microcontroller, so that the microcontroller is able to dictate the functions of the present invention. The microcontroller is a processing device (PCB-printed circuit board) that interprets commands received from the HID and uses these commands to manage the operation of the electrical components within the present invention.

According to the preferred embodiment, a user may enter the battery characteristics like kilowatts, amperes, etc. through an application on a mobile computing device so that, the critical heat level of that battery may be automatically calculated by the microcontroller and the thermostat set to a certain temperature. To accomplish this, the present invention comprises a wireless communication module, that connects and communicates with a mobile computing device via wireless data transmission protocols. Example standards of what the wireless communication module is capable of using include, but are not limited to, Bluetooth, WI-FI, GSM, CDMA, ZigBee, etc. The mobile computing device may be any smart device such as a mobile phone, a computer, or any wirelessly connected computing system. To enable smooth functioning of the present invention, the mobile computing device is communicably coupled to the wireless communication module, and the wireless communication module is electronically coupled to the microcontroller.

To provide electric power to the battery and the rest of the device, an external power source is provided. Preferably, the external power source is a wall outlet on a charging station, to which a power plug of the thermostat device may be plugged into. Furthermore, the present invention may comprise other power outlets, electric plugs, and connection wires, integrated through the receptacle and between the various components of the present invention, that helps with the smooth functioning of the present invention.

Thus, according to the present invention, the battery system of an e-bike is first connected to the programmable thermostat device, externally through a wired plug. The specifications of the battery may be entered through the mobile computing device, which would automatically set the critical temperature of the thermostat. Alternately, the critical temperature may be set by adjusting the HID of the thermostat device. Once the critical temperature is set, charging of the battery may begin, and the heat sensor associated with the device would constantly monitor the temperature of the battery. If at any point, the battery reaches the critical temperature, the heat sensor would send that information to the microcontroller, which in turn would send the command to the circuit breaker. The circuit breaker would disrupt the connection between the external power source and the battery, thereby preventing any overheating mis happenings.

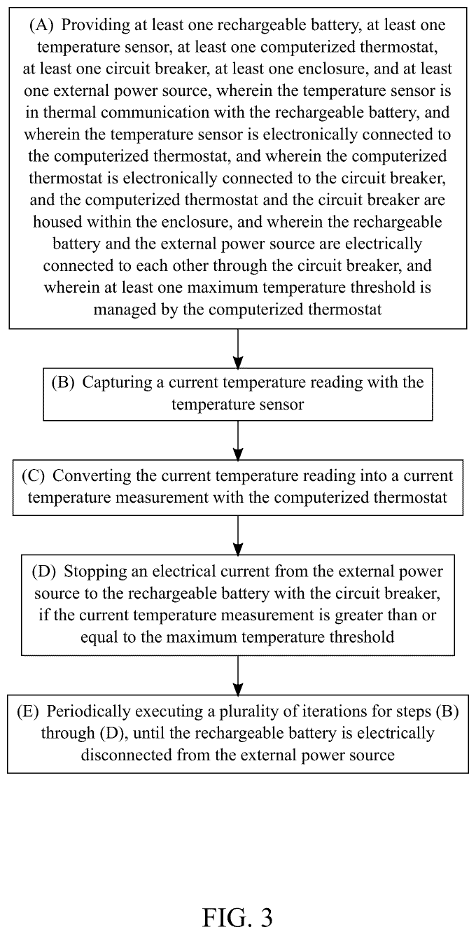

In an alternate embodiment of the present invention and in reference to FIG. 3, the programmed thermostat may be used for multiple batteries. In this embodiment, multiple sensors are required. In other words, for each battery an associated heat sensor is linked, and for each sensor there is an outlet with a circuit breaker. In this embodiment, if one battery among the plurality of batteries reaches the critical temperature level, charging may be stopped for just that battery.

In another alternate embodiment, the present invention comprises a built-in smoke detector for safety. This is because any electrical system that may burst will emit fumes. The addition of a smoke detector with noise alarm will add another layer of safety to the system. In its most sophisticated configuration, the invention would be (through Wi-Fi or blue tooth) linked to the home security system (e.g., ADT, Vivint, etc.) triggering an automatic call to the fire department. In a more basic the configuration the invention with a built-in smoke detector will trigger a loud noise alarm that would call to action anybody in the vicinity.

Although the invention has been explained in relation to its preferred embodiment, it is to be understood that many other possible modifications and variations can be made without departing from the spirit and scope of the invention.

What is claimed is:

1. A method of preventing a rechargeable battery for an electrically-motorized personal vehicle from overheating, the method comprising the steps of:
(A) providing at least one rechargeable battery, at least one temperature sensor, at least one computerized thermostat, at least one circuit breaker, at least one enclosure, and at least one external power source, wherein the temperature sensor is in thermal communication with the rechargeable battery, and wherein the temperature sensor is electronically connected to the computerized thermostat, and wherein the computerized thermostat is electronically connected to the circuit breaker, and the computerized thermostat and the circuit breaker are housed within the enclosure, and wherein the rechargeable battery and the external power source are electrically connected to each other through the circuit breaker, and wherein at least one maximum temperature threshold is managed by the computerized thermostat;
(B) capturing a current temperature reading with the temperature sensor;
(C) converting the current temperature reading into a current temperature measurement with the computerized thermostat;
(D) stopping an electrical current from the external power source to the rechargeable battery with the circuit breaker, if the current temperature measurement is greater than or equal to the maximum temperature threshold; and
(E) periodically executing a plurality of iterations for steps (B) through (D), until the rechargeable battery is electrically disconnected from the external power source.

2. The method as claimed in claim 1 comprising the steps of:
providing at least one user interface module, wherein the user interface module is integrated into an external surface of the enclosure, and wherein the user interface module is electronically connected to the computerized thermostat;
prompting to enter a maximum temperature selection with the user interface module before step (B); and
designating the maximum temperature selection as the maximum temperature threshold with the computerized thermostat, if the maximum temperature selection is entered through the user interface module.

3. The method as claimed in claim 1 comprising the steps of:
providing at least one wireless communication module and at least one remote computing device, wherein the wireless communication module is housed within the enclosure, and wherein the wireless communication module is electronically connected to the computerized thermostat, and wherein the remote computing device is located outside of the enclosure, and wherein the wireless communication module is communicably coupled to the remote computing device through the wireless communication module;
prompting to enter a maximum temperature selection with the remote computing device before step (B);
relaying the maximum temperature selection from the remote computing device, through the wireless communication device, and to the computerized thermostat, if the maximum temperature selection is entered through the remote computing device; and
designating the maximum temperature selection as the maximum temperature threshold with the computerized thermostat.

4. The method as claimed in claim 1, wherein the maximum temperature threshold is a predetermined temperature value managed by the computerized thermostat.

5. The method as claimed in claim 1 comprising the steps of:
providing at least one user interface module, wherein the user interface module is integrated into an external surface of the enclosure, and wherein the user interface module is electronically connected to the computerized thermostat;
generating a warning notification with the computerized thermostat during step (D), if the current temperature measurement is greater than or equal to the maximum temperature threshold; and
outputting the warning notification with the user interface module, if the warning notification is generated by the computerized thermostat.

6. The method as claimed in claim 1 comprising the steps of:
providing at least one wireless communication module and at least one remote computing device, wherein the wireless communication module is housed within the enclosure, and wherein the wireless communication module is electronically connected to the computerized thermostat, and wherein the remote computing device is located outside of the enclosure, and wherein the computerized thermostat is communicably coupled to the remote computing device through the wireless communication module;
generating a warning notification with the computerized thermostat during step (D), if the current temperature measurement is greater than or equal to the maximum temperature threshold;
relaying the warning notification from the computerized thermostat, through the wireless communication device, and to the remote computing device, if the warning notification is generated by the computerized thermostat; and
outputting the warning notification with the remote computing device.

7. The method as claimed in claim 1 comprising the steps of:
providing at least one computerized smoke detector, wherein the computerized smoke detector is mounted to an external surface of the enclosure, and wherein the computerized smoke detector is electronically connected to the circuit breaker;
monitoring for a smoke detection reading with the computerized smoke detector; and
stopping the electrical current from the external power source to the rechargeable battery with the circuit breaker, if the smoke detection reading is monitored by the computerized smoke detector.

8. The method as claimed in claim 7 comprising the steps of:
providing at least one user interface module, wherein the user interface module is integrated into the external surface of the enclosure, and wherein the user interface module is electronically connected to the computerized smoke detector;
generating a warning notification with the computerized smoke detector, if the smoke detection reading is monitored by the computerized smoke detector; and
outputting the warning notification with the user interface module, if the warning notification is generated by the computerized smoke detector.

9. The method as claimed in claim 7 comprising the steps of:
providing at least one wireless communication module and at least one remote computing device, wherein the wireless communication module is housed within the enclosure, and wherein the wireless communication module is electronically connected to the computerized smoke detector, and wherein the remote computing device is located outside of the enclosure, and wherein the computerized smoke detector is communicably coupled to the remote computing device through the wireless communication module;
generating a warning notification with the computerized smoke detector, if the smoke detection reading is monitored by the computerized smoke detector;
relaying the warning notification from the computerized smoke detector, through the wireless communication device, and to the remote computing device, if the warning notification is generated by the computerized smoke detector; and
outputting the warning notification with the remote computing device.

10. The method as claimed in claim 1, wherein the rechargeable battery is a battery from an e-bicycle.

11. The method as claimed in claim 1, wherein the rechargeable battery is a battery from an e-scooter.

12. The method as claimed in claim 1, wherein the enclosure is made of a thermally-conductive material, and wherein the temperature sensor is housed within the enclosure, and wherein the temperature sensor is mounted adjacent to an internal surface of the enclosure, and the temperature sensor is in thermal communication with the rechargeable battery through the enclosure.

13. The method as claimed in claim 1, wherein the temperature sensor is located outside of the enclosure, and wherein the temperature sensor is tethered to the enclosure.

14. The method as claimed in claim 1, wherein at least one power-in port and at least one power-out port are integrated into the enclosure, and wherein the power-in port is electrically connected to the power-out port through the circuit breaker, and wherein the external power source is electrically plugged into the power-in port, and the wherein the rechargeable battery is electrically plugged into the power-out port.
